(19) United States
(12) Patent Application Publication
(10) Pub. No.: US 2016/0293142 A1
(43) Pub. Date: Oct. 6, 2016

(54) GRAPHICAL USER INTERFACE (GUI) SHADING BASED ON CONTEXT

(71) Applicants: Upton Beall Bowden, Canton, MI (US); Dale O. Cramer, Royal Oak, MI (US); Kyle Entsminger, Canton, MI (US)

(72) Inventors: Upton Beall Bowden, Canton, MI (US); Dale O. Cramer, Royal Oak, MI (US); Kyle Entsminger, Canton, MI (US)

(21) Appl. No.: 14/675,080

(22) Filed: Mar. 31, 2015

(51) Int. Cl. G09G 5/37; G06T 11/00; G09G 5/02

(52) U.S. Cl. CPC G09G 5/37; G09G 5/02; G06T 11/001; G09G 2380/10; G09G 2360/144; G09G 2320/08; G09G 2320/066; G06T 2200/28

(57) ABSTRACT

Systems, methods, and instrument cluster display devices are provided herein to provide a graphical user interface (GUI) shading element. The GUI shading element replicates a shadow produced by a mechanical element (for example, a pointer on a gauge) in a mechanical display structure. The aspects disclosed herein detect a location of the Sun independent of a light sensor.

### BACKGROUND

Conventionally, in many environments, displays were implemented with mechanical elements, such as switches, pointers, dials, and the like. The mechanical elements may be coupled to various sensors and electronic systems, and configured to move or change status based on received information.

The mechanical elements may project or provide a three-dimensional experience to the viewer. For example, in the situation where a pointer is employed, the pointer may be placed over a surface of indicia, and connected with a stem that facilitates the projection of the pointer.

FIG. 1 illustrates an example of a mechanical display 100 according to a conventional implementation. As shown in FIG. 1, the mechanical display 100 includes indicia 110, a pointer 120, and a stem 130. The stem 130 facilitates the pointer 120 to be in a plane different than the indicia 110. In response to light being received from a light source 150 (as shown as the Sun in FIG. 1), a shadow 140 is generated.

In recent times, mechanical displays are now being replaced with digital or electronic displays. The digital or electronic display may receive rendering information from a source, such as a digital driving circuit, and render digital information in accordance with received information.

For example, in an instrument cluster of a vehicle, a digitally provided pointer may be provided. The pointer may be employed to display various elements of an automotive function, such as the speed, fuel capacity, revolutions-per-minute (RPM), or the like. The digital display information may ultimately be employed to render a graphical user interface (GUI) element in accordance with the received information.

The transition from a mechanical user interface (UI) to a digital UI may be viewed by some as less authentic or real. Thus, this transition is often viewed as an un-aesthetic decision.

### SUMMARY

The following description relates to providing a graphical user interface (GUI) shading element based on a received parameter. Exemplary embodiments may also be directed to any of the system, the wireless charging device, a display, or combinations thereof.

Additional features of the invention will be set forth in the description which follows, and in part will be apparent from the description, or may be learned by practice of the invention.

A system for providing a graphical user interface (GUI) shading element on a digital display with a GUI element is provided herein. The system includes an orientation receiver to receive information about an orientation associated with a viewer of the display; a solar detector, based on the received orientation and a present time, to detect a location of a Sun; and a re-renderer to render the GUI shading element based on the GUI element. The GUI shading element is rendered to replicate a mechanical version of the GUI element would produce.

A method for providing a graphical user interface (GUI) shading element on a digital display with a GUI element is provided herein. The method includes obtaining information about an orientation of a digital display; determining a location of the Sun based on the orientation and a time of day; and rendering the GUI shading element for a GUI element to replicate a shadow generated by a mechanical object being represented by the GUI element.

It is to be understood that both the foregoing general description and the following detailed description are exemplary and explanatory and are intended to provide further explanation of the invention as claimed. Other features and aspects will be apparent from the following detailed description, the drawings, and the claims.

### DESCRIPTION OF THE DRAWINGS

The detailed description refers to the following drawings, in which like numerals refer to like items, and in which:

FIG. 1 illustrates an example of a mechanical display according to a conventional implementation.

FIG. 2 illustrates an example of the mechanical display implemented as a digital display.

FIG. 3 is a block diagram illustrating an example computer.

FIG. 4 illustrates a system for incorporating shading based on location information for display.

FIG. 5 illustrates a method for incorporating shading based on location information for a display.

FIGS. 6(a) and (b) illustrate an example implementation of the system in FIG. 4 and the method in FIG. 5.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

Displays such as those found in instrument clusters, may provide information to a viewer based on a variety of information received from sensors, such as electronic sensors or the like. As explained in the Background section, the displays were conventionally implemented with mechanical elements, such as gauges, rotary knobs, and the like. Mechanical elements created shadows, such as shadow 140 shown in FIG. 1.

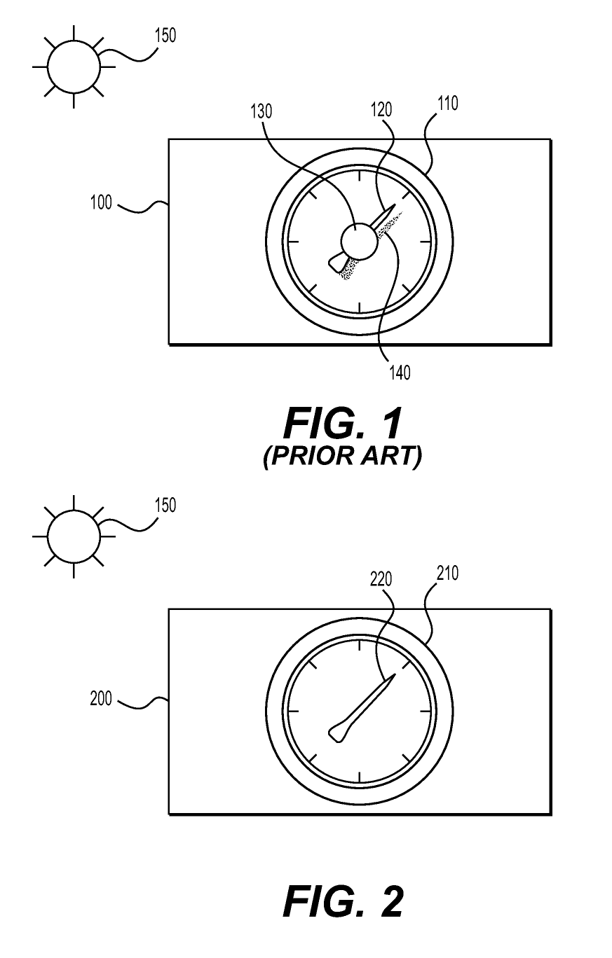

Increasingly, displays are becoming digital. FIG. 2 illustrates an example of the mechanical display 100 implemented as a digital display 200. The digital display 200 shown in FIG. 2 includes various GUI elements, such as GUI element 210 for the indicia and GUI element 220 for a pointer. The digital display 200 may appear to be somewhat stale and unaesthetic to the viewer.

Thus, an implementer of the display 200 may desire that the display 200 be more realistic (i.e. replicative of the mechanical display 100). Various techniques may be employed, for example, as shown in FIG. 2, the digital display 200 may be configured to replicate a mechanical display 100 in look and feel. However, various factors may be left out.

Disclosed herein are systems, methods, and display devices incorporating a Graphical User Interface (GUI) shading based on a specific context. Employing the aspects disclosed herein, a display 200 may replicate realistic shading effects even though a digital display encompasses a single plane. Accordingly, an implementer of a digital display 200 may provide a more realistic (i.e. replicative of mechanical displays) and aesthetically pleasing environment.

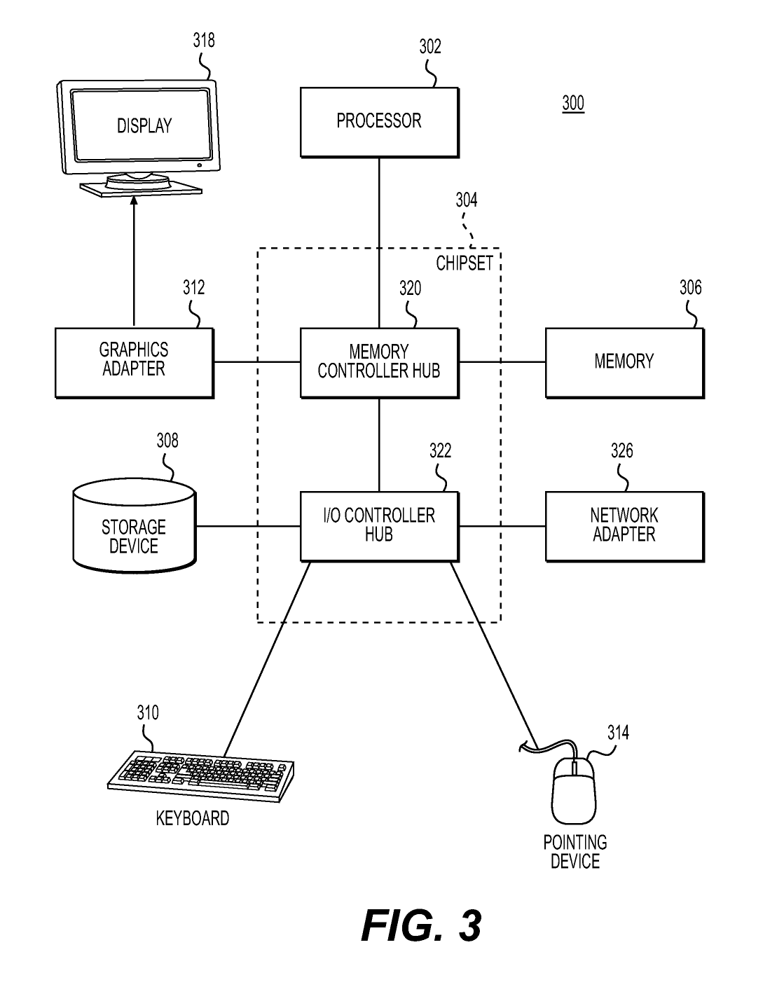

FIG. 3 is a block diagram illustrating an example computer 300. The computer 300 includes at least one processor 302 coupled to a chipset 304. The chipset 304 includes a memory controller hub 320 and an input/output (I/O) controller hub 322. A memory 306 and a graphics adapter 312 are coupled to the memory controller hub 320, and a display 318 is coupled to the graphics adapter 312. A storage device 308, keyboard 310, pointing device 314, and network adapter 316 are coupled to the I/O controller hub 322. Other embodiments of the computer 300 may have different architectures.

The storage device 308 is a non-transitory computer-readable storage medium such as a hard drive, compact disk read-only memory (CD-ROM), DVD, or a solid-state memory device. The memory 306 holds instructions and data used by the processor 302. The pointing device 314 is a mouse, track ball, steering wheel controls, other types of automotive touch screen controls, or other type of pointing device, and is used in combination with the keyboard 310 to input data into the computer 300. The pointing device 314 may also be a gaming system controller, or any type of device used to control the gaming system. For example, the pointing device 314 may be connected to a video or image capturing device that employs biometric scanning to detect a specific user. The specific user may employ motion or gestures to command the point device 314 to control various aspects of the computer 300.

The graphics adapter 312 displays images and other information on the display 318. The network adapter 316 couples the computer system 300 to one or more computer networks.

The computer 300 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 308, loaded into the memory 306, and executed by the processor 302.

The types of computers used by the entities and processes disclosed herein can vary depending upon the embodiment and the processing power required by the entity. The computer 300 may be a mobile device, tablet, smartphone or any sort of computing element with the above-listed elements. For example, a data storage device, such as a hard disk, solid state memory or storage device, might be stored in a distributed database system comprising multiple blade servers working together to provide the functionality described herein. The computers can lack some of the components described above, such as keyboards 310, graphics adapters 312, and displays 318.

The computer 300 may act as a server (not shown) for the content sharing service disclosed herein. The computer 300 may be clustered with other computer 300 devices to create the server. The various computer 300 devices that constitute the server may communicate with each other over a network 450.

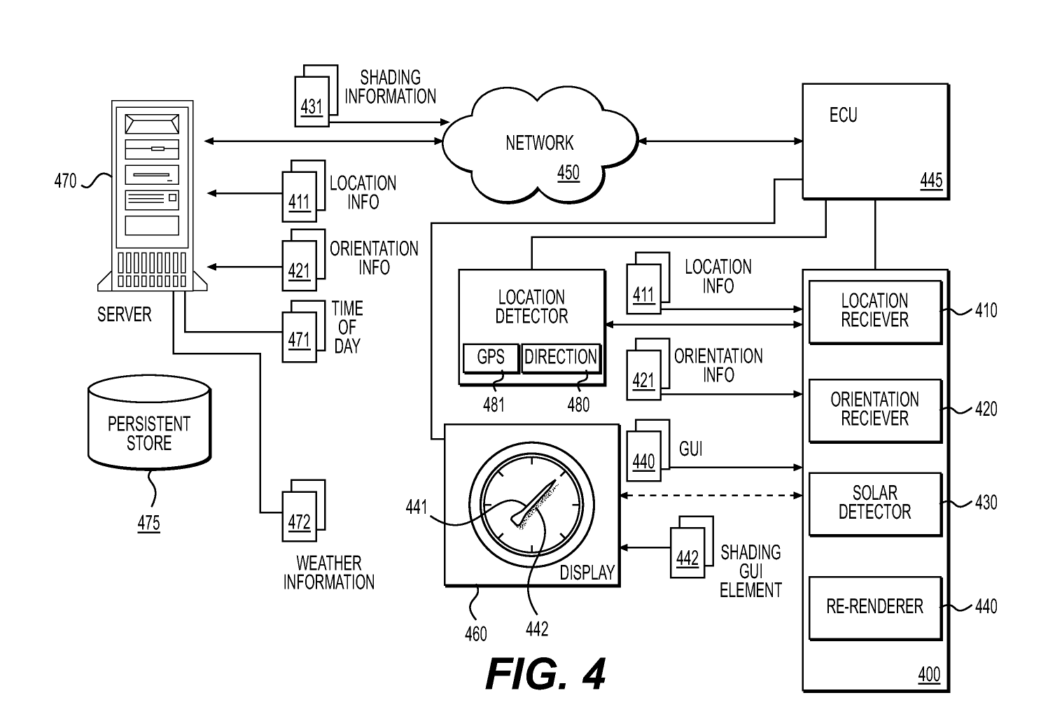

FIG. 4 illustrates a system 400 for incorporating shading based on location information for display 460. A display 460 is an electronic display system configured to replicate digital data via lighted elements.

The system 400 may be implemented on a processor, such as computer 300 shown above. The system 400 includes a location receiver 410, an orientation receiver 420, a solar detector 430, and a re-renderer 440.

The system 440 may be coupled to (either wired or wirelessly) to an electronic control unit (ECU) 445. The ECU 445 communicates information to and from the various electronic componentry shown in FIG. 4. In one example, the ECU 445 is connected to a server 470 via the network 450.

As shown in FIG. 4, the ECU 445 receives an input from the system 400, and retrieves information from the server 470 over the network 445. In an alternate example, the information retrieved may be retrieved from local storage, such as a persistent store 475 shown in FIG. 4. The persistent store 475 may be any of the storage devices enumerated above with regards to storage device 308. In FIG. 4, the persistent store 475 is connected to the system 400 via network 450. However, in another example, the persistent store 475 may be locally provided.

Also shown in FIG. 4 is an electronic display 460. The electronic display 460 is configured to display various graphical user interface (GUI) elements, such as GUI element 441 and 442. In the example shown, GUI element 441 is a pointer associated with a gauge. When an electronic system indicates a value (such as a fuel amount, speed, or the like), the GUI element 441 is rendered into a location on the electronic display 460 based on the amount associated with the electronic system's indication. The rendering of GUI element 442 is accomplished by system 400, and a detailed explanation will be discussed further down below.

The location receiver 410 interfaces with the location detector 480, and receives digital information (location information 411) associated with the current location of the system 400 and/or the ECU 445 (or the vehicle or object associated with the ECU 445). The location information 411 may be any data associated with the present location, such as a coordinate, a point on a map, or the like. The location detector 480 may source this information with a global positioning satellite (GPS) 481.

In the example shown in FIG. 4, the GPS 481 is provided as integrated with a location detector 480. However, the information may also be received via a GPS 481 integrated into a situation or context where the ECU 445 is provided in. Many vehicles include built-in GPS systems. Accordingly, the built-in GPS system may be configured to operate or work with the system 400 in a similar fashion.

The location information 411 may be stored in a temporary register or memory, such as those described above with regards to storage device 308.

The orientation receiver 420 receives orientation information 421 of the object in which the ECU 445 and/or the system 400 is located in. Orientation information 421 corresponds to a direction (i.e. north, south, west, and east) related to where the ECU 445′s vehicle or viewer of the display 460 is pointed towards. In the example in which FIG. 4 represents a vehicle, if the driver and the front are the vehicle are facing north, the orientation information 421 may indicate ‘north’.

In one example, the orientation information 421 is obtained from the GPS 481. However, other orientation detection techniques may also be employed, such as the use of a compass (shown as a direction 482).

The solar detector 430 communicates the location information 411 and the orientation information 421 to the server 470, via network 450 (or to a local database not connected to the network 450). In response, the server 470 may cross-reference a lookup table, and retrieve via persistent store 475, shading information 431.

The shading information 431, in one example, may be an indication as to where the sun or light source is. In this implementation, the shading information 431 may then be processed by the solar detector 430 to produce a shading GUI element 442.

In another example, the server 470 may be configured to deliver the shading GUI element 442 directly. In this case, the server 470 may cross-reference the persistent store 475, and communicate the shading GUI element 442 (instead of the shading information 431) to the system 400. In this scenario, the solar detector 430 is not configured to process anything to render or create the shading GUI element 442.

The shading GUI element 442 is then communicated to the display 460 via the re-renderer 440. The re-renderer 440 may take the existing image being display onto the display 460, and add the shading GUI element 442. Alternatively, the shading GUI element 442 may be communicated to the ECU 445, and re-rendered via a display driver 446 include as part of the ECU 445. Thus, the images and information conveyed via display 460 may include the GUI shading element 442.

The GUI shading element 442 is a representation of a shadow associated with the GUI element 441, if the GUI element 441 were a mechanical (i.e. non-digital) element. Thus, the GUI shading element 442 may be based on knowledge of the location 411 and the orientation 421. The estimated position of the Sun (or other light source) may be determined from just the compass related information. However accuracy of the Sun position is improved with more information, such as the at least the two information pieces associated above. Further, the estimated position of the Sun may also be known by the time of day 471.

In another example, not shown, the estimated position of the Sun may be also aided by the knowledge of present weather information 472. In this case, the generation of the shading GUI element 442 may represent whether the day is sunny (i.e. a shadow would appear), or overcast (i.e. a shadow would most likely not appear).

In the manner described above, the system 400 may facilitate the generation and feel of a non-digital display, while still maintaining a digital display.

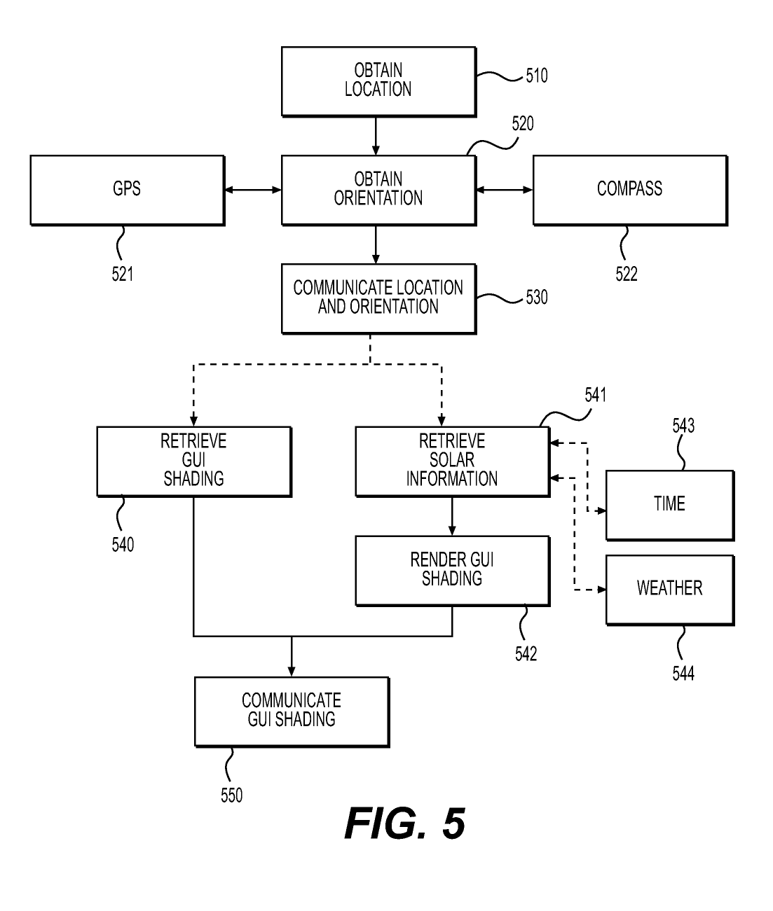

FIG. 5 illustrates a method 500 for incorporating shading based on location information for a display. The method 500 may be stored on a computer, such as computer 300 shown above. The various concepts discussed with regards to method 500 and its operation may be similarly incorporated into the system 400, and vice versa.

In operation 510, a location is obtained. The location may be obtained via location detection techniques known, such as a GPS or the like. Once the location is known, in operation 520, an orientation may be obtained. The orientation refers to the direction in which the viewer of the display is looking at.

There are several ways to obtain orientation, two of which are shown in FIG. 5. An implementation of method 500 may incorporate both methods, and thus, is not limited to one or the other. In operation 521, a GPS is relied on for orientation. However, in another example, an orientation detection device, such as a compass may be employed (operation 522).

In the method 500 shown in FIG. 5, both the location and the orientation are obtained. However, in certain implementations of method 500, only the orientation may be obtained. If both the location and orientation are obtained, the accuracy of noting where the Sun's location is relative to the display may be increased.

The importance of obtaining either or both the location of the display and the orientation of the viewer of a display is that the relative location of the Sun may be determined. For example, if the Sun is in the west, and the viewer of the display is in a car traveling northward, by knowing the orientation of the viewer (i.e. that he/she is facing northward), the knowledge of the Sun's interaction with the display may also be ascertained. In this way, the knowledge of what shadow to produce onto the display may be determined.

In operation 530, the information obtained in operations 510 and 520 are communicated to a server or processor configured to translate the information obtained to information capable of translating to a generated shadow. The information obtained in operations 510 and 520 may be combined with other known information, such as the time of day, and/or present weather condition.

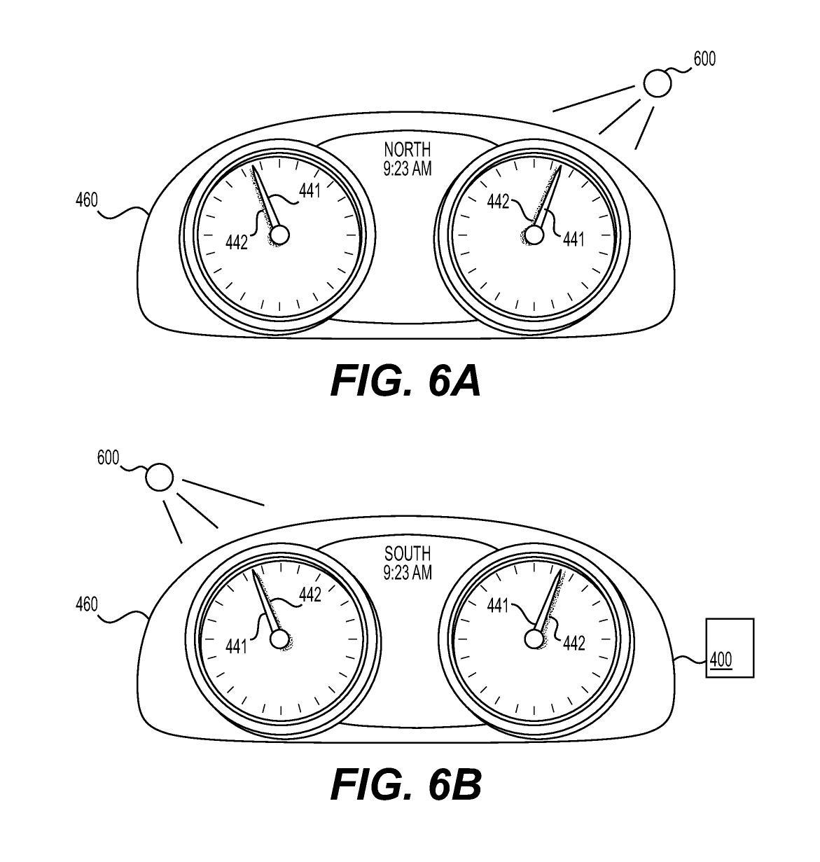

In FIG. 5, two different implementations of method 500 are shown. In one implementation, the method 500 proceeds to operation 540. In operation 540, a GUI element associated with the shading is retrieved. The shading GUI element may be employed to augment an already existing GUI element on the display. In the example shown in FIGS. 6(a) and (b), the already existing GUI element is a pointer, and the shading GUI element replicates a shadow in a similar manner as such if the display were a mechanical gauge shown in FIG. 1.

In another implementation, as shown by the branch in connecting operation 530 and 541, the shading GUI element is generated with the obtained information in operations 510 and 520 (or just operation 520).

In operation 541, the location of the Sun is retrieved. This may be accomplished by the obtained information, and augmented by the time 543. Further, in another example, the weather 544 may be retrieved (i.e. from a weather server).

In operation 542, the information obtained (either all or some) is then employed to re-create a shading GUI element. The shading GUI element (in operation 550) is communicated to the display associated 500.

FIGS. 6(a) and (b) illustrate an example implementation of the system 400 and the method 500. The display 460 shown is an instrument cluster in a vehicle. The instrument cluster shows various indicia, gauges, and other commonly found information conveying screens in a standard instrument cluster implementation.

Also shown in FIGS. 6(a) and (b) is a Sun 600. As shown, by the time indication, the Sun 600 is at a different part of the sky relative to the time and the orientation of the vehicle. In FIG. 6(a), the vehicle is facing north. In FIG. 6(b), the vehicle is facing south. In both cases, the time is the same.

Employing the aspects disclosed herein, the GUI pointer elements 441 may have a shading GUI element 442 augmented onto the display. As such, a digitally rendered shadow is created in each of the display 460′s presentations.

The system 400 only needs to be cognizant of the location, orientation (or just orientation), and the time of day. As explained above, in other implementations, weather information may also be employed. Once those factors are known, the shading GUI element 442 may be created, and rendered onto a display 460. As shown in FIGS. 6(a) and (b), the shading GUI element 442 replicates the shadow that would be created if the GUI pointer 441 were a mechanical pointer.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

We claim:

1. A system for providing a graphical user interface (GUI) shading element on a digital display with a GUI element, comprising:
an orientation receiver to receive information about an orientation associated with a viewer of the display;
a solar detector, based on the received orientation and a present time, to detect a location of a Sun; and
a re-renderer to render the GUI shading element based on the GUI element, wherein the GUI shading element is rendered to replicate a mechanical version of the GUI element would produce.

2. The system according to claim 1, further comprising a location receiver to receive information about the location of the display, wherein the solar detector detects the location of the Sun further based on the location of the display.

3. The system according to claim 2, wherein the system communicates the received orientation and the received location of the display to a server, and receives via the server the location of the Sun.

4. The system according to claim 2, wherein the solar detector is configured to calculate the location of the Sun.

5. The system according to claim 3, further comprising rendering the GUI shading element based on a present weather condition.

6. An instrument cluster display, comprising:
a digital display screen configured to digitally represent a graphical depiction of a mechanical gauge, the digital display configured to render a graphical user interface (GUI) element of a mechanical pointer;
a solar detector to detect the location of the Sun independent of a light sensor, wherein
the digital display renders a GUI shading element based on the detected location of the Sun, wherein the GUI shading element is rendered relative to the GUI element of the mechanical pointer.

7. The instrument cluster display according to claim 6, wherein the location of the Sun is detected via information provided via a global positioning satellite (GPS).

8. The instrument cluster display according to claim 6, wherein the location of the Sun is detected via information provided via a compass.

9. The instrument cluster display according to claim 6, wherein the rendering is based on a present weather condition.

10. A method for providing a graphical user interface (GUI) shading element on a digital display with a GUI element, comprising:
obtaining information about an orientation of a digital display;
determining a location of the Sun based on the orientation and a time of day; and
rendering the GUI shading element for a GUI element to replicate a shadow generated by a mechanical object being represented by the GUI element,
wherein the obtaining, determining, and rendering is performed via a processor.

11. The method according to claim 10, further comprising obtaining information about the location of the digital display, and rendering the GUI shading element further based on the location of the digital display.

12. The method according to claim 10, further comprising obtaining information about a present weather condition, and rendering the GUI shading element further based on the present weather condition.
